(19) United States
(12) Patent Application Publication
(10) Pub. No.: US 2004/0252438 A1
(43) Pub. Date: Dec. 16, 2004

(54) Method and apparatus for a subnanosecond response time transient protection device

(75) Inventors: John Jerome Mankowski, Lubbock, TX (US); Robert Michael Pap, Chattanooga, TN (US); Louie Cecil Elliott, Chattanooga, TN (US); Peter George Krueger, Ooltewah, TN (US); Clifton James Murphy, Chattanooga, TN (US); Frances Jeanes Vine, Chattanooga, TN (US); Richard Ephrain Saeks, Chattanooga, TN (US)

Correspondence Address: Janet C. Donovan, 7001 Shallowford Road, Chattanooga, TN, 37421, US

(73) Assignee: Accurate Automation Corporation, Chattanooga, TN

(21) Appl. No.: 10/459,497

(22) Filed: Jun. 12, 2003

Related U.S. Application Data
(60) Provisional application No. 60/387,921, filed on Jun. 13, 2002.

(51) Int. Cl. H02H 9/06

(52) U.S. Cl. 361/120

(57) ABSTRACT

A plasma limiter is a transient suppression device that combines fast rise time response similar to that of a solid state diode and the high power handling capability similar to that of a traditional gas discharge tube. The limiter is ideally suited to provide front-end protection of radar equipment from electronic warfare systems such as High Power Ultra Wideband (HPUWB) and High Power Microwaves (HPM) as well as protection from lightning and static discharges. It achieves this high order of protection by having a turn-on time of less than 1 nanosecond, a power handling capability of greater than 10 kW, and an insertion loss of less than 0.1 dB.

Provisional Patent Ser. No. 60/387,921 filed Jun. 13, 2002

RELATED U.S. PATENT DOCUMENTS

| | | |
|---|---|---|
| 4,866,563 | December 1989 | Howard et al. |
| 5,166,855 | November 1992 | Turner |
| 5,500,782 | May 1996 | Oertel et al. |
| 5,508,873 | April 1996 | Knapp et al. |

Other Publications

Kikel, Altgilbers, Merritt, Brown, Ray, and Zhang, 1998, “Plasma Limiters,” AIAA paper AIAA-98-2564.

Krompholz, Hatfield, Short, Kristiansen, 2000, “Sub-Nanosecond Gas Breakdown Phenomena in the Voltage Regime Below 15 kV,” Presented to EURO Electromagnetics Conference, Edinburgh, Scotland, 30 May-2 June.

Mankowski, Dickens, and Kristiansen, 1998, “High Voltage Subnanosecond Breakdown,” IEEE Trans. on Plasma Science, vol. 26, no. 3.

Mankowski and Kristiansen, 2000, “A Review of Short Pulse Generator Technology,” IEEE Trans. on Plasma Science, vol. 28, no. 1.

Mankowski, 1997, “High Voltage Subnanosecond Breakdown,” Texas Tech University Ph.D. Dissertation.

Nasser, 1961, Fundamentals of Gaseous Ionization and Plasma Electronics, Wiley Interscience, New York.

Raizer, 1997, Gas Discharge Physics, Springer, Berlin.

### GOVERNMENTAL SUPPORT

This work was supported under the following SBIR contracts:

Army SMDC Phase I Contract Number DASG60-01-C-0018

Army SMDC Phase II Contract Number DASG60-01-C-0088

### BACKGROUND OF THE INVENTION

This invention relates to plasma limiters and gas discharge tubes, and the like, found in radar receiver protection systems. The widespread use of communication devices and radar systems has made our present day society increasingly vulnerable to the effects of high-power, short-pulse electromagnetic interference (EMI) and high power microwaves (HPM). Significant advances in technology which produce these high-power, short pulses have been made in the US and abroad in the past few decades. As a result, the need for devices that can protect sensitive communications equipment from these pulses is greater than ever.

More particularly, this invention relates to a type of plasma limiter capable of turn-on in 1 nanosecond and less, using initiation of streamer breakdown via a micron radius needle tip of at least one of a plurality of metal needles, and being disposed in a background of at least one low pressure background inert gas, such as argon.

A plasma limiter or a gas discharge tube according to this invention is a device that has the potential to protect sensitive communications equipment from short pulse EMI and HPM, and such limiters essentially short circuit the transmission line being used to receive communication signals. Once the transmission line is short-circuited, all incident RF radiation is reflected and prevented from propagating to the sensitive electronic devices downstream of the receiver. After the EMI or HPM pulse ends, the discharge across the plasma limiter extinguishes and the entire system recovers.

Gas discharge protective devices have been used for decades on communications equipment. Originally, these devices were designed to protect equipment from EMI and other electromagnetic pulses, resulting from lightning strikes, for example, or nuclear detonation. As a result, these devices operate with slow rise times, typically microseconds, and they tend to be quite bulky, although they may protect equipment from high amplitude electric fields.

As may be observed from the current art provided by the above referenced patents, devices that provide protection from high power transients can be categorized as either solid-state devices or gas discharge tubes. Solid-state devices such as silicon avalanche diodes and metal-oxide varistors have extremely fast turn-on times of 1 psec and high peak power capability (˜100 kW); however, they have low average power handling capability (<10 W). Conversely, conventional gas discharge tubes can easily handle average powers greater than 1 kW, but have inherently slow turn-on times (>100 nsec).

Prior inventions are poorly suited to protect sensitive electronics from High Power Microwaves (HPM) which are electromagnetic radiation in the microwave regime (1 to 100 GHz) with high peak power (>10 kW). These pulses can be produced by any number of devices including high power magnetrons, klystrons, and backward wave oscillators. As such, most electronic equipment is susceptible to upset or destruction from exposure to HPM whether it is from “friendly” high power radar systems or from “non-friendly” directed energy weapons. Of particular vulnerability are devices designed to receive microwave signals such as radar, wireless communication devices, and satellites. These devices have front-doors, such as an antennas, that allow the easy access of HPM to sensitive receiver electronics.

The other type of electromagnetic radiation from which protection is desired is high-power Ultra-Wideband (UWB) which are created from high-power, ultra-fast switching devices, typically spark gaps. In the time domain, the waveform shape of a UWB pulse has a rise time of <1 nsec and pulse width of several nanoseconds. These UWB sources can achieve peak pulse powers of >1 GW with repetition rates ˜1 kHz. Unlike HPM, UWB contains a broad spectrum of frequencies, therefore, UWB does not necessarily need a front-door to disrupt and destroy sensitive electronics. Additionally, UWB sources are far less complicated to design and construct than HPM sources, which makes them well suited as a terrorist threat. The features of this invention provide a method and means for protection against such threat systems.

### BRIEF SUMMARY OF THE INVENTION

Plasma limiters provide protection from high power transients and possess the capability of turn-on times less than a nanosecond and power handling capability of >1 kW. Conventional gas discharge tubes are capable of this level of power handling capability but require turn-on times >100 nsec. The faster turn-on time of the plasma limiter is achieved through a gas breakdown process called streamer breakdown as opposed to the avalanche breakdown utilized in conventional gas discharge tubes.

Avalanche gas breakdown initially starts with a free electron located somewhere between a pair of electrodes. When an electric field is applied between the electrodes, the free electron experiences a force which accelerates the electron until it collides with a neutral atom or molecule. If the electron has gained enough kinetic energy, the collision is inelastic and the neutral atom is ionized. The collision results in two free electrons and one positive ion. The process then repeats, and the two electrons become four, and so on. This process is known as an electron avalanche, and if enough avalanches occur over a period of time the gas temperature increases thereby lowering the gap resistance. As the gap resistance drops, the electrical driving circuit heats the gap more efficiently. The gap resistance then drops rapidly along with the gap voltage to very low values at which time complete electrical breakdown has occurred.

The streamer breakdown process utilized in the plasma limiter device is faster than the avalanche breakdown process described above. A streamer discharge starts out much like a Townsend breakdown with an initial electron avalanche. At high electric fields and moderate pressures the electron avalanche will grow such that the self generated electric field at the head of the avalanche becomes on the order of the electric field across the gap. This self-generated electric field causes locally intense ionization at the head of the avalanche. This ionization results in photoemission and photoionization that develop into additional electron avalanches. The temporal development of streamers is a very fast process. Streamers can cross 1 cm gaps in times <1 nsec, dependent upon the magnitude of the applied voltage, gas pressure, and the non-uniformity of the E-field.

In the plasma limiter device of this invention, the high electric field is achieved by the fine tip needle electrode or electrodes. FIG. 1a shows a plasma limiter with fine tip needle electrodes within a rectangular waveguide geometry. The microdimension of the tip is determined by the overall waveguide geometry; for an X-band waveguide (0.4″×0.9″) the tip radius would need to be <1 micron. This tip radius provides an electric field enhancement up to 1000 times. Therefore, a relatively low electric field applied to the waveguide of 10 volts/cm would be 10 kV/cm near the tip of the electrode.

### BRIEF DESCRIPTION OF THE DRAWINGS

These and other features and advantages will become more apparent from a detailed consideration of the invention when taken in conjunction with drawings in which:

FIGS. 1a and 1b show respectively a front and side cross sectional view of the plasma limiter device employing a needle-to-needle electrode assembly within its rectangular waveguide geometry according to a preferred embodiment of this invention;

FIGS. 2a and 2b show respectively a front and side cross sectional view of the plasma limiter device employing a knife edge to knife edge electrode assembly within its rectangular waveguide geometry;

FIG. 3 shows a side cross sectional view of the plasma limiter device employing a needle-to-needle electrode assembly within its rectangular waveguide geometry with the inclusion of a steady-state DC corona discharge being applied to the upper electrode thereof;

FIG. 4 shows a side cross sectional view of the plasma limiter device employing a needle-to-needle electrode assembly within its micro-strip geometry; and,

FIGS. 5a and 5b show respectively a front and side cross sectional view of the plasma limiter device employing a needle electrode assembly within its coaxial geometry.

### DETAILED DESCRIPTION OF THE INVENTION

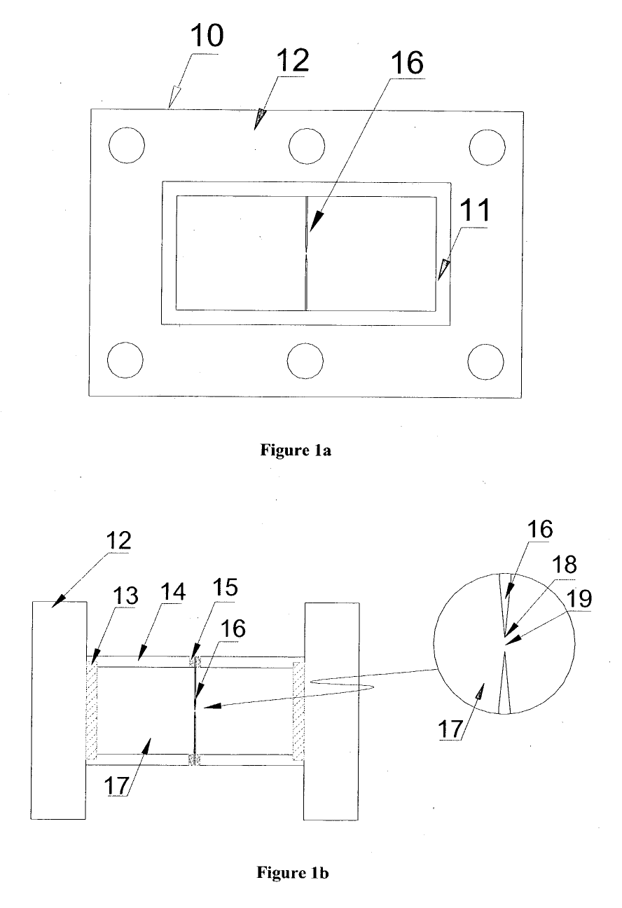

Referring now to the drawings of FIGS. 1a and 1b there is shown a plasma limiter 10 within its waveguide geometry 11 including a rectangular waveguide flange 12 having an interface 13 sealing the limiter from its outside environment, and bounded within by a waveguide wall 14 sealed by insert 15 used to insulate electrode needles 16 from wall 14. An appropriate background inert gas 17 fills space within the waveguide wall 14. The needles 16 are provided with a needle tip 18 having a typical radius <1 micron, and a gap 19 is provided between needle tips 18 as appropriate.

Needles in the arrangement of FIGS. 1a and 1b provide the localized electric field enhancement required to initiate the streamer breakdown process previously described, and in order to provide multiple usages without degradation to the electrodes, the material making up the needles 16 is comprised of a durable conductive substance such as tungsten, and like material construction, such as tungsten carbide, diamond coated tungsten, and any like hard material acting as a good electron field emission material. The gap 19 preferably is defined as a distance that must be approximately 100 times the radius of the tip 18 (<0.1 mm). The interface 13 is constructed such to be transparent to incident microwave reception.

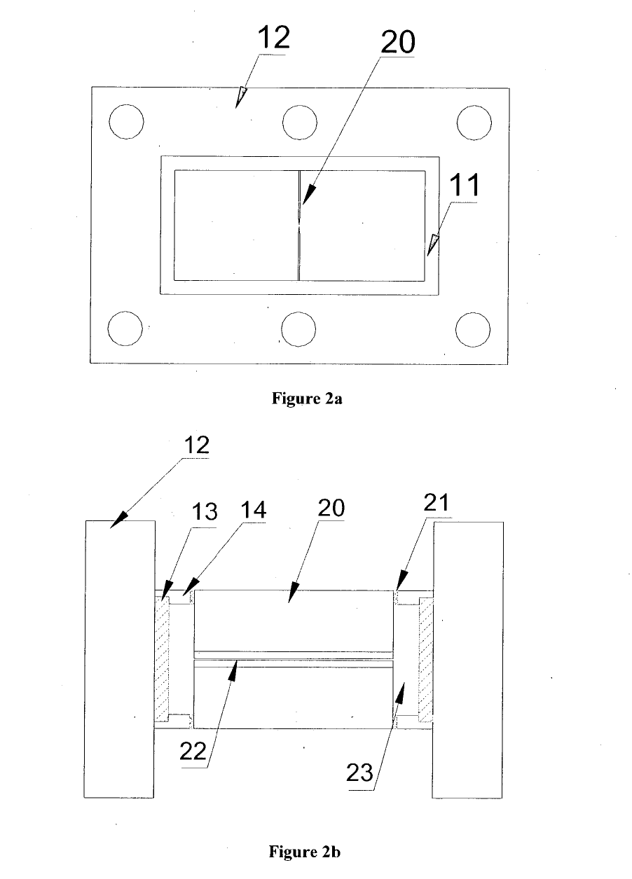

FIGS. 2a and 2b show the plasma limiter in its rectangular waveguide geometry 11 with knife edge electrodes 20 as similar in some respects to the electrode needles 16 of FIGS. 1a and 1b and sealed insert 21 as similar in respects to the sealed insert 15 of FIGS. 1a and 1b, for insulating the knife edge electrodes from the waveguide walls. As in FIGS. 1a and 1b, the edge terminal of the knife edge is less than one micron with a gap 22 between the knife edges defined as above (<0.1 mm). Appropriate background inert gas 23 fills space within the waveguide walls.

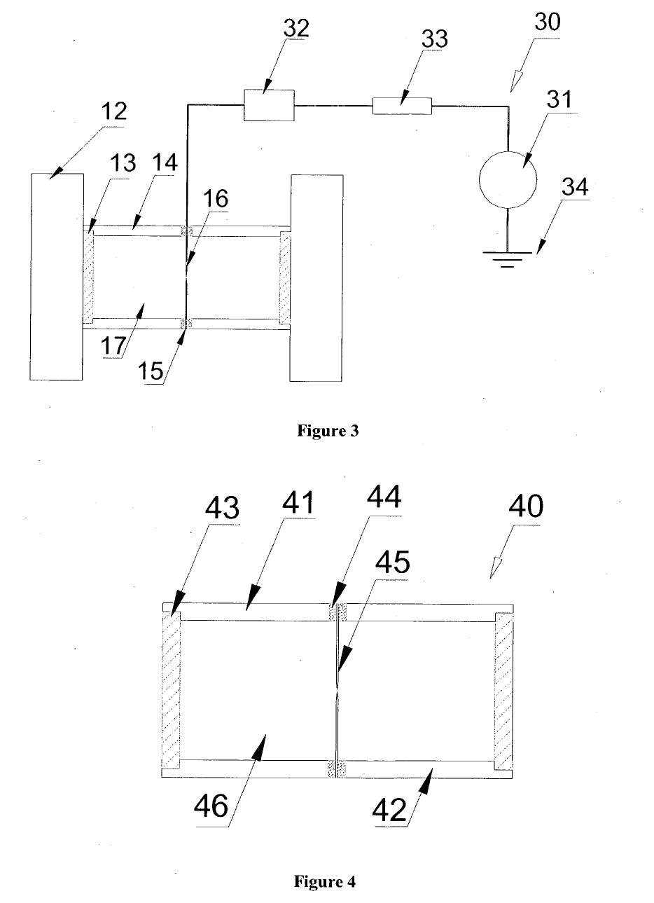

A plasma limiter is shown in FIG. 3 with its flange 12, interface 13, rectangular waveguide wall 14, and insert 15 having a constant corona discharge applied to an electrode from biasing circuit 30. Circuit elements include but are not limited to a miniature high voltage DC power supply source 31, an RF choke 32, a current limiting resistor 33, and a connection to ground 34. Background inert gas 17 is furnished between needles 16 and supported by interface 13 and walls 14.

In FIG. 4 is shown and disclosed a plasma limiter disposed in its parallel-plate or microstrip waveguide geometry 40. Two additional parts are shown as an upper plate 41 and lower plate 42 of its parallel-plate geometry supported by its interface 43 and insert 44 for needles 45 and in a background inert gas 46, which act in spirit similar to their counterparts in FIGS. 1 and 2 although their realization may be different.

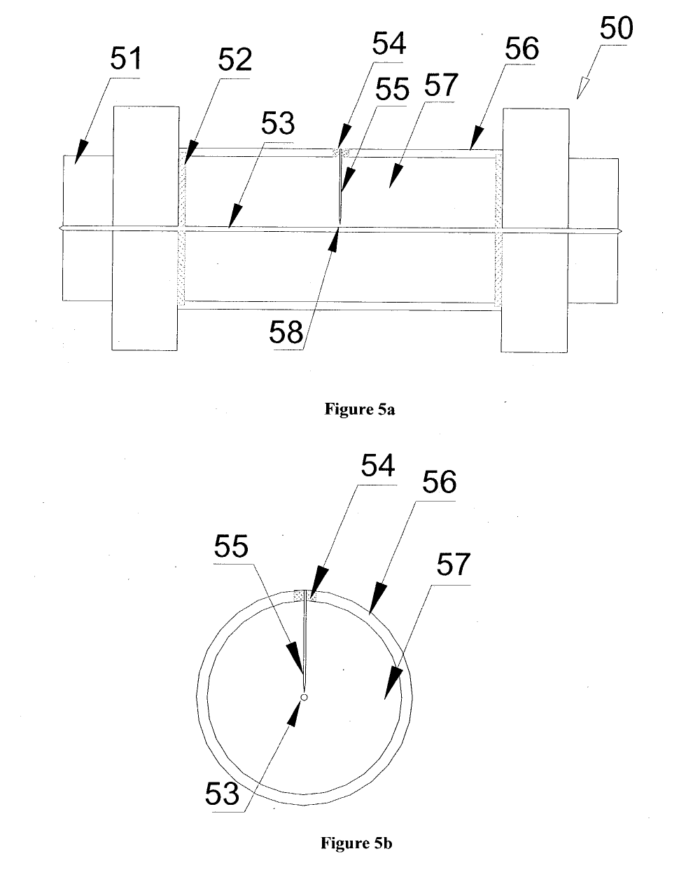

FIGS. 5a and 5b show another modified yet essentially similar plasma limiter 50 and its coaxial geometry, with its parts described as a coaxial connector 51, an interface 52 necessary to seal the limiter, an inner conductor 53 of its coaxial geometry, a sealed insert 54 for insulating an electrode needle 55 from the outer conductor 56, a background inert gas 57 and a gap 58 disposed between the needle 55 and the inner conductor 53.

The many features and advantages of this invention are apparent from the detailed specification and its description, and thus, it is intended by the appended claims to cover all such features and advantages of the describes apparatus and methods which follow in the true spirit and scope of the invention. Further, since numerous modifications and changes will readily occur to those of ordinary skill in the art, it is not desired to limit the invention to the exact construction and operation illustrated and described. Accordingly, all suitable modifications and equivalents may be resorted to as falling with the spirit and scope of the invention.

1) A plasma limiter transient protection device for being disposed between a transmitting/receiving antenna and sensitive electronic devices comprised of:
(a) a gas discharge means having at least one of a plurality of metal needles positioned in a streamer breakdown region having a tip of radius less than 1 micron within a background of at least one low pressure background inert gas,
(b) means providing a radiated energy field to travel in selective directions between the transmitting/receiving antenna and the sensitive devices, and
(c) the metal needle including the tip being an electron field emission device.

2) The invention of claim 1 wherein the metal of the needle is tungsten, or like material.

3) The invention of claim 1 wherein the background gas is argon, or like inert gas.

4) The invention of claim 1 wherein a high voltage bias is applied to one needle electrode such that a steady state corona discharge exists locally proximate the tip of the needle.

5) The invention of claim 1 wherein there are means to provide an AC or DC voltage bias.

6) The invention of claim 1 wherein the interface is a microwave transparent material.

7) The invention of claim 1 wherein the electrode tip has a geometric shape with an edge within the defined radius of less than 1 micron.

8) The invention of claim 1 wherein the geometry of the radiant energy field is selected from a group of geometries that are rectangular, circular, coaxial, parallel-plate, and microstrip.

9) The invention of claim 1 wherein a delay line is disposed in line with a circuit electric device.

10) The invention of claim 1 wherein a radioactive beta emitter gas is included with the background inert gas for electron seeding of the gap.
